(19) United States
(12) Patent Application Publication
(10) Pub. No.: US 2025/0365827 A1
(43) Pub. Date: Nov. 27, 2025

(54) WAVEGUIDE DEVICE, MICROWAVE IRRADIATION DEVICE, AND MICROWAVE TRANSMISSION METHOD

(71) Applicant: Microwave Chemical Co., Ltd., Osaka (JP)

(72) Inventors: Hisao WATANABE, Osaka (JP); Yasunori TSUKAHARA, Osaka (JP)

(73) Assignee: Microwave Chemical Co., Ltd., Osaka (JP)

(21) Appl. No.: 18/576,337

(22) PCT Filed: Jul. 5, 2022
(86) PCT No.: PCT/JP2022/026710

§ 371 Date: Jun. 24, 2024

(30) Foreign Application Priority Data
Jul. 5, 2021 (JP) 2021-111372

(51) Int. Cl. H05B 6/72

(52) U.S. Cl. CPC H05B 6/72

(57) ABSTRACT

Provided is a waveguide apparatus that can adjust the electromagnetic field distribution inside a cavity in which a target is subjected to microwave irradiation. A waveguide apparatus includes: a first waveguide for microwaves that is fixed to a wall of a cavity so as to be at least partially located outside the wall, a target inside the cavity being subjected to microwave irradiation; and a second waveguide through which microwaves from the first waveguide are guided into the cavity, wherein the second waveguide is connected to the first waveguide such that an output direction of microwaves into the cavity is changeable.

### CROSS REFERENCE TO RELATED APPLICATIONS

This is a U.S. national phase application under 35 U.S.C. 371 of International Patent Application No. PCT/JP2022/026710, filed Jul. 5, 2022, which claims benefit of priority to Japanese Patent Application No. 2021-111372, filed Jul. 5, 2021. The entire contents of these applications are hereby incorporated by reference.

### FIELD OF THE INVENTION

The present invention relates to a waveguide apparatus for transmitting microwaves, a microwave irradiation apparatus having the waveguide apparatus, and a microwave transmitting method.

### BACKGROUND

Conventionally, targets are irradiated with microwaves inside cavities to cause a reaction to occur in the targets or to dry the targets. In such microwave irradiation inside the cavities, the direction of microwave irradiation has been fixed.

### SUMMARY

In designing cavities for irradiating targets with microwaves, electromagnetic field analysis simulations are performed to determine the shape of a cavity, the position of microwave irradiation, the direction of irradiation, and the like according to the simulation results such that the microwave irradiation is optimized. However, even if cavities are designed based on the simulation results, optimal microwave irradiation may not always be realized because the electromagnetic field distribution inside a reaction unit may be changed by factors that cannot be reproduced in simulations, such as droplets adhering to the wall of the reaction unit, a reaction system in which the liquid level changes over time, changes in the height of the liquid level or internal structure of the reaction unit after design, or the like. In such a situation, the electromagnetic field distribution inside the cavity needs to be adjusted to realize optimal microwave irradiation, which requires operations such as opening the reaction unit and adding a structure to adjust the electromagnetic field distribution, resulting in an increase in the number of processes.

The present invention was made in view of these problems, and it is an object thereof to provide a waveguide apparatus, a microwave irradiation apparatus, and a microwave transmitting method that are capable of easily adjusting the electromagnetic field distribution inside a cavity in which a target is subjected to microwave irradiation.

In order to achieve the above-mentioned object, an aspect of the present invention is directed to a waveguide apparatus including: a first waveguide for microwaves that is fixed to a wall of a cavity so as to be at least partially located outside the wall, inside the cavity a target being subjected to microwave irradiation; and a second waveguide through which microwaves from the first waveguide are guided to be output into the cavity, wherein the second waveguide is connected to the first waveguide such that an output direction of microwaves into the cavity is changeable.

Furthermore, an aspect of the present invention may be directed to the waveguide apparatus, wherein the first waveguide includes: an input-side waveguide to which microwaves generated by a microwave generator are input; and a first joint portion having a first central axis and including a partially solid cylinder-like shaped hollow portion in which a first opening that is connected to the input-side waveguide and a second opening that is continuous with the first opening are arranged, and the second waveguide includes: a second joint portion having a second central axis and having a partially solid cylinder-like shape in which a third opening to which microwaves from the first opening are guided and a fourth opening that is continuous with the third opening are arranged, the second joint portion being disposed so as to be pivotable inside the hollow portion about the second central axis; and an output-side waveguide that is connected to the fourth opening and configured to output microwaves into the cavity.

Furthermore, an aspect of the present invention may be directed to the waveguide apparatus, wherein the first central axis and the second central axis are coaxial.

Furthermore, an aspect of the present invention may be directed to the waveguide apparatus, wherein the first opening and the second opening are located such that opening planes thereof are parallel to the first central axis, and the third opening and the fourth opening are located such that opening planes thereof are parallel to the second central axis.

Furthermore, an aspect of the present invention may be directed to the waveguide apparatus, wherein the first waveguide includes: an input-side waveguide to which microwaves generated by a microwave generator are input; and a first joint portion having a solid cylinder-like shaped first hollow portion whose peripheral face has a first opening that is connected to the input-side waveguide and whose end in a central axial direction thereof has a second opening that is continuous with the first opening, and the second waveguide includes: a second joint portion having a solid cylinder-like shaped second hollow portion whose end in a central axial direction thereof has a third opening to which microwaves from the first hollow portion are guided and whose peripheral face has a fourth opening that is continuous with the third opening, the second joint portion being connected to the first joint portion so as to be pivotable about the central axis of the second hollow portion with respect to the first joint portion; and an output-side waveguide that is connected to the fourth opening and configured to output microwaves into the cavity.

Furthermore, an aspect of the present invention may be directed to the waveguide apparatus, wherein the first and second hollow portions are coaxially continuous with each other.

Furthermore, an aspect of the present invention may be directed to the waveguide apparatus, wherein the second joint portion is connected so as to be movable in the central axial direction of the second hollow portion with respect to the first joint portion.

Furthermore, an aspect of the present invention may be directed to the waveguide apparatus, wherein a circular spacer is provided in a gap between the first and second joint portions.

Furthermore, an aspect of the present invention may be directed to the waveguide apparatus, further including: an operation unit that is connected to the second joint portion and configured to pivot the second joint portion from an outside of the cavity in a state in which the first waveguide is fixed to the wall of the cavity.

Also, an aspect of the present invention is directed to a microwave irradiation apparatus including: a microwave generator that generates microwaves; a cavity in which a target is subjected to microwave irradiation; and a waveguide apparatus that is fixed to the cavity and configured to introduce microwaves generated by the microwave generator into the cavity.

Also, an aspect of the present invention is directed to a microwave transmitting method for transmitting microwaves from an outside to an inside of a cavity in which a target is subjected to microwave irradiation, using a waveguide apparatus including a first waveguide for microwaves that is fixed to a wall of the cavity so as to be at least partially located outside the wall, and a second waveguide through which microwaves from the first waveguide are guided to be output into the cavity, the second waveguide being connected to the first waveguide such that an output direction of microwaves into the cavity is changeable, including: a step of changing an output direction of microwaves from the second waveguide into the cavity.

Furthermore, an aspect of the present invention may be directed to the microwave transmitting method, further including: a step of sensing an electromagnetic field distribution or a state of the target inside the cavity, wherein, in the step of changing an output direction of microwaves, the output direction of microwaves from the second waveguide is changed using a sensing result such that the electromagnetic field distribution or the target is in a desired state.

### ADVANTAGEOUS EFFECTS OF INVENTION

In accordance with the waveguide apparatus, the microwave irradiation apparatus, and the microwave transmitting method according to an aspect of the present invention, the output direction of microwaves into a cavity is changeable, and thus the electromagnetic field distribution inside the cavity can be easily adjusted.

### BRIEF DESCRIPTION OF DRAWINGS

FIG. 1 is a perspective view of a waveguide apparatus according to Embodiment 1 of the present invention.

FIG. 2 is a front view of the waveguide apparatus according to the embodiment.

FIG. 3 is a side view of the waveguide apparatus according to the embodiment.

FIG. 4 is a cross-sectional view of the waveguide apparatus according to the embodiment.

FIG. 5 is a perspective view of a second waveguide according to the embodiment.

FIG. 6 is a cross-sectional schematic view of a microwave irradiation apparatus according to the embodiment.

FIG. 7 is a perspective view of a waveguide apparatus according to Embodiment 2 of the present invention.

FIG. 8 is a front view of the waveguide apparatus according to the embodiment.

FIG. 9 is a plan view of the waveguide apparatus according to the embodiment.

FIG. 10 is a cross-sectional view of the waveguide apparatus according to the embodiment.

FIG. 11 is a partially enlarged cross-sectional view of the waveguide apparatus according to the embodiment.

FIG. 12A is a cross-sectional schematic view of the microwave irradiation apparatus according to the embodiment.

FIG. 12B is a cross-sectional schematic view of the microwave irradiation apparatus according to the embodiment.

FIG. 12C is a cross-sectional schematic view of the microwave irradiation apparatus according to the embodiment.

FIG. 13 is a front view of a waveguide apparatus according to Embodiment 3 of the present invention.

FIG. 14 is a side view of the waveguide apparatus according to the embodiment.

FIG. 15 is a cross-sectional view of the waveguide apparatus according to the embodiment.

FIG. 16 is a cross-sectional view of the waveguide apparatus according to the embodiment.

### DETAILED DESCRIPTION

Below, a waveguide apparatus, a microwave irradiation apparatus, and a microwave transmitting method according to an aspect of the present invention will be described by way of embodiments. The constituent elements denoted by the same reference numerals in the embodiments described below are the same or similar constituent elements, and thus a description thereof may not be repeated.

### Embodiment 1

Hereinafter, a waveguide apparatus, a microwave irradiation apparatus, and a microwave transmitting method according to Embodiment 1 of the present invention will be described with reference to the drawings. The waveguide apparatus according to this embodiment is configured such that first and second waveguides are connected to each other at a first joint portion including a partially solid cylinder-like shaped hollow portion and a partially solid cylinder-like shaped second joint portion that is disposed so as to be pivotable inside the hollow portion.

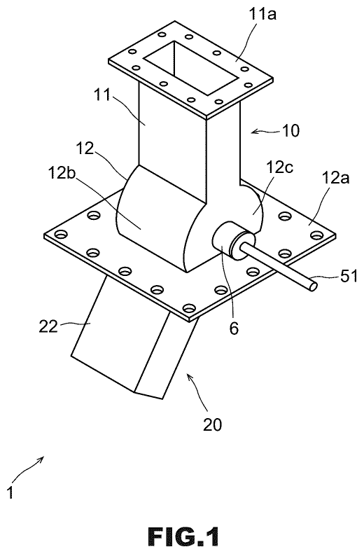

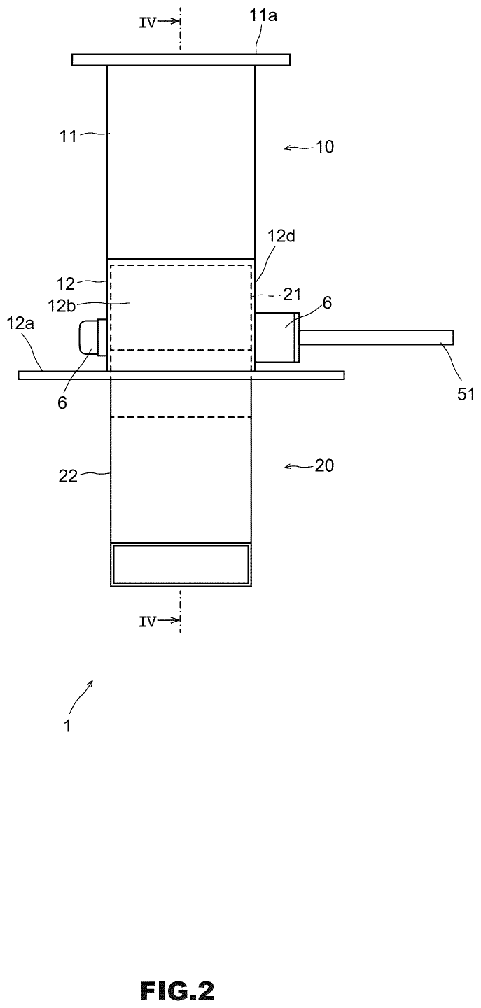

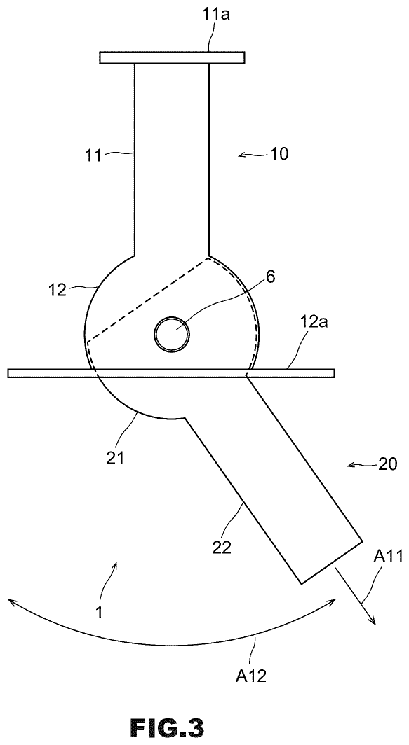

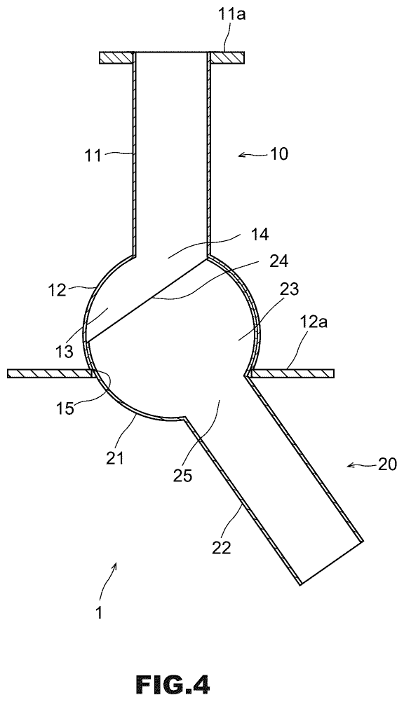

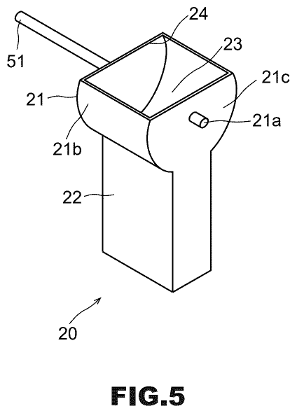

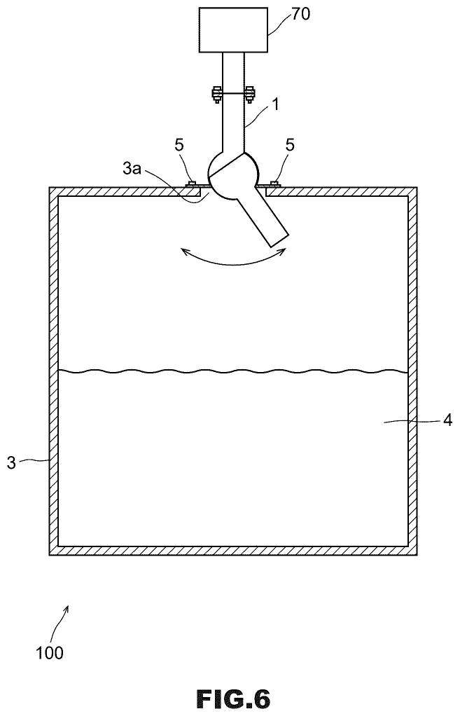

FIG. 1 is a perspective view of a waveguide apparatus 1 according to this embodiment, FIG. 2 is a front view of the waveguide apparatus 1, FIG. 3 is a side view of the waveguide apparatus 1, FIG. 4 is a cross-sectional view taken along the line IV-IV in FIG. 2, and FIG. 5 is a perspective view of a second waveguide 20. FIG. 6 is a cross-sectional schematic view of a microwave irradiation apparatus 100 including a cavity 3 and the waveguide apparatus 1 that is attached to the cavity 3.

As shown in FIG. 6, the waveguide apparatus 1 according to this embodiment is fixed to the cavity 3 in which a target 4 is subjected to microwave irradiation, and is used to introduce microwaves from the outside to the inside of the cavity 3. The microwave irradiation apparatus 100 includes the waveguide apparatus 1, the cavity 3, and a microwave generator 70. The waveguide apparatus 1 includes a first waveguide 10 that is fixed to the wall of the cavity 3 and a second waveguide 20 through which microwaves from the first waveguide 10 are guided to be output into the cavity 3, and may further include an operation unit 51 for pivoting the second waveguide 20. The second waveguide 20 is connected to the first waveguide 10 such that the output direction of microwaves into the cavity 3 is changeable. The first waveguide 10 is fixed to the wall of the cavity 3 such that at least part of the first waveguide 10, for example, an end of the first waveguide 10 on the side to which microwaves are input is located outside the wall.

The first waveguide 10 includes an input-side waveguide 11 to which microwaves generated by the microwave generator 70 are input, and a first joint portion 12 that is fixed to the wall of the cavity 3. The first joint portion 12 includes a partially solid cylinder-like shaped first hollow portion 13 that is connected to the input-side waveguide 11.

The second waveguide 20 includes a partially solid cylinder-like shaped second joint portion 21 that is disposed so as to be pivotable inside the first hollow portion 13, and an output-side waveguide 22 that outputs microwaves from the second joint portion 21 into the cavity 3.

Both of the first and second waveguides 10 and 20 transmit microwaves, and thus they are preferably made of a material that does not allow microwaves to pass therethrough. The material that does not allow microwaves to pass therethrough may be, for example, a microwave-reflective material. The microwave-reflective material may be, for example, a metal. There is no particular limitation on the metal, but examples thereof include stainless steel, carbon steel, aluminum, aluminum alloys, nickel, nickel alloys, copper, copper alloys, and the like.

In the cavity 3, the target 4 may be, for example, heated, fired, chemically reacted, dried, freeze-dried, waste treated, or sterilized, through microwave irradiation. The cavity 3 may be, for example, a heating vessel, a reactor, a drying vessel, a waste treatment vessel, a sterilization vessel, or a kiln. The cavity 3 preferably has a wall that does not allow microwaves to pass therethrough, in order to prevent microwaves from leaking from the interior space. Therefore, the wall of the cavity 3 may be made of a microwave-reflective material. The microwave-reflective material may be, for example, a metal. Examples of the metal are as described above. The target 4 that is irradiated with microwaves may be, for example, a solid such as a solid matter, a granular solid, or a powder, a liquid, a gas, or a mixture thereof. The target 4 may or may not be stirred inside the cavity 3. The microwave irradiation apparatus 100 may be, for example, a continuous apparatus or a batch apparatus. If it is a continuous apparatus, the target 4 may be, for example, continuously moved or may be repeatedly moved and stopped.

The waveguide apparatus 1 transmits microwaves generated by the microwave generator 70 into the cavity 3. The microwave generator 70 that generates microwaves may generate microwaves, for example, using a magnetron, a klystron, a gyrotron, a semiconductor element, or the like. The generating microwaves using a semiconductor device may be, for example, oscillating microwaves using a semiconductor device or amplifying microwaves using a semiconductor device. The frequency band of the microwaves may be, for example, in the vicinity of 915 MHZ, 2.45 GHZ, 5.8 GHZ, or 24 GHz, or other frequency bands in the range of 300 MHz to 300 GHz. The size of the microwave guide path for microwaves in the waveguide apparatus 1 preferably corresponds to the frequency of microwaves that are to be transmitted therethrough.

The input-side waveguide 11 in the first waveguide 10 may be, for example, a rectangular waveguide or a circular waveguide. The input-side waveguide 11 may be, for example, a straight waveguide, a corner waveguide in which the microwave guide path is bent at a right angle or other angles and the outer circumference of the corner portion is beveled, or a bent waveguide in which the microwave guide path is curved into a circular arc. The input-side waveguide 11 may be, for example, a hollow waveguide. The same applies to the output-side waveguide 22 in the second waveguide 20. In this embodiment, a case will be mainly described in which the input-side waveguide 11 and the output-side waveguide 22 are hollow, straight, and rectangular waveguides. An end of the input-side waveguide 11 on the microwave generator 70 side may be provided with a flange 11a as shown in FIG. 1, but there is no limitation to this. The end of the input-side waveguide 11 on the microwave generator 70 side may be connected to, for example, the microwave generator 70, or may be connected to a waveguide connected to the microwave generator 70.

The first joint portion 12 in the first waveguide 10 includes the first hollow portion 13 having a partially solid cylinder-like shape. In this embodiment, a case will be mainly described in which the first joint portion 12 is formed in one piece with the input-side waveguide 11 with a constant thickness and the outer shape of the first joint portion 12 is also a partially solid cylinder-like shape as with the first hollow portion 13, that is, the first joint portion 12 has a partially hollow cylinder-like shape with both ends in the axial direction closed, but there is no limitation to this. If the outer shape of the first joint portion 12 is not a partially solid cylinder-like shape, for example, the outer shape of the first joint portion 12 may be a rectangular cuboid shape, and the first hollow portion 13 having a partially solid cylinder-like shape may be located inside the rectangular cuboid shape.

The first hollow portion 13 has a first opening 14 and a second opening 15. Accordingly, the first and second openings 14 and 15 are continuous with each other via the first hollow portion 13. The first opening 14 is connected to the input-side waveguide 11. Part of the second waveguide 20 is inserted into the first hollow portion 13 from the second opening 15 side. Both of the first and second openings 14 and 15 are located such that opening planes thereof are parallel to the central axis of the first hollow portion 13. The first hollow portion 13 has a partially solid cylinder-like shape due to the provision of such first and second openings 14 and 15 on the peripheral face of the solid cylinder-like shaped hollow portion. Accordingly, the central axis of the first hollow portion 13 is the central axis of the inner peripheral face other than the first and second openings 14 and 15 in the first hollow portion 13. The peripheral face of the solid cylinder-like shape is a face of a cylindrical shape parallel to the axial direction of the solid cylinder-like shape. Through hole into which pivoting shafts 21a of the second joint portion 21 are inserted are formed respectively through a pair of bottom faces 12c of the first joint portion 12 having a partially hollow cylinder-like shape in which the pair of bottom faces 12c oppose each other. The through holes are located on the central axis of the first hollow portion 13.

In this embodiment, a case is shown in which the opening planes of the first and second openings 14 and 15 are parallel to each other and the opening planes oppose each other with the central axis of the first hollow portion 13 interposed therebetween, but there is no limitation to this. The opening planes of the first and second openings 14 and 15 may not be parallel to each other.

The solid cylinder-like shape may be a regular cylindrical shape, that is, a shape whose cross-section that is perpendicular to the central axis is a regular circle, or a shape whose cross-section is slightly deviated from a regular circle, for example, an oval or regular polygonal shape. The shapes whose cross-section that is perpendicular to the axial direction is a regular circle or slightly deviated from a regular circle are collectively referred to as a “solid cylinder-like shape”. The solid cylinder-like shape is typically solid. If the solid cylinder-like shape is a regular cylindrical shape, the peripheral face is a circumferential face. The cylindrical shapes whose outer shape is a solid cylinder-like shape and whose interior includes a solid cylinder-like shaped hollow portion are referred to as a “hollow cylinder-like shape”.

The first joint portion 12 is fixed to the wall of the cavity 3 preferably such that the central axis of the first hollow portion 13 is parallel or nearly parallel to the plane direction of the wall. This is because it is preferable for the second opening 15 to face the inside of the cavity 3 in a state in which the first joint portion 12 is fixed to the cavity 3. In this embodiment, a case will be mainly described in which the entire first joint portion 12 is located outside the wall of the cavity 3 in a state in which the first joint portion 12 is fixed to the wall of the cavity 3. As shown in FIG. 1, a mounting plate 12a may be fixed to the first joint portion 12. The first joint portion 12 may be fixed to the cavity 3 by fixing the mounting plate 12a to the wall of the cavity 3 with bolts 5 as shown in FIG. 6. The mounting plate 12a may have an opening of the same size and same shape as the second opening 15, and the opening and the second opening 15 may be connected by welding or the like such that they coincide as viewed from the normal direction of the mounting plate 12a. If the first joint portion 12 is not provided with the mounting plate 12a, the first joint portion 12 may be fixed to the wall of the cavity 3, for example, by welding.

The second joint portion 21 in the second waveguide 20 has a partially solid cylinder-like shape, and has third and fourth openings 24 and 25 that are continuous with a second hollow portion 23 inside the joint portion. Accordingly, the third and fourth openings 24 and 25 are continuous with each other via the second hollow portion 23. Microwaves from the first opening 14 of the first joint portion 12 are guided via the first hollow portion 13 to the third opening 24. Both of the third and fourth openings 24 and 25 are located such that opening planes thereof are parallel to the central axis of the partially solid cylinder-like shape of the second joint portion 21. The central axis of the partially solid cylinder-like shape of the second joint portion 21 is the central axis of the peripheral face other than the third and fourth openings 24 and 25 in the second joint portion 21. The pivoting shafts 21a are respectively provided in a pair of bottom faces 21c that oppose each other in the second joint portion 21 having a partially solid cylinder-like shape. The pivoting shafts 21a may be fixed to the bottom faces 21c, for example, by welding, screwing, or the like. The pivoting shafts 21a are located on the central axis of the second joint portion 21. FIG. 5 shows a case in which there is no pivoting shaft 21a in the second hollow portion 23, but there is no limitation to this. There may be a pivoting shaft 21a in the second hollow portion 23. In this case, the pivoting shaft 21a may be provided through the bottom faces 21c. If there is a pivoting shaft 21a in the second hollow portion 23, at least the portion of the pivoting shaft 21a that is located in the second hollow portion 23 is preferably made of a material that does not reflect microwaves. The material that does not reflect microwaves is preferably a microwave-transmissive material. The microwave-transmissive material is a material with low relative dielectric loss, and examples thereof include, but are not particularly limited to, a fluororesin such as polytetrafluoroethylene, quartz, and glass. The relative dielectric loss of the microwave-transmissive material is, for example, preferably smaller than 1, more preferably smaller than 0.1, and even more preferably smaller than 0.01, at the frequency and temperature of microwaves when the microwaves irradiation apparatus 100 is in operation. From the viewpoint of reducing reflection or absorption of microwaves in the second hollow portion 23, it is preferable that there is no pivoting shaft 21a in the second hollow portion 23. As shown in FIG. 1 and the like, the operation unit 51 extending in one direction is connected to an end of a pivoting shaft 21a. The pivoting shaft 21a and the operation unit 51 may be formed in one piece.

If the third opening 24 side of the second joint portion 21 of the second waveguide 20 cannot be placed inside the first hollow portion 13 through the second opening 15 or if the pivoting shafts 21a are attached to the bottom faces 21c by welding or the like, the first waveguide 10 may be assembled by connecting the faces around the second joint portion 21 by welding or the like. On the other hand, if the pivoting shafts 21a can be attached to the bottom faces 21c by screwing or the like and the third opening 24 side of the second joint portion 21 of the second waveguide 20 can be placed inside the first hollow portion 13 through the second opening 15, the second waveguide 20 may be placed into the first hollow portion 13 of the first waveguide 10 and then the pivoting shafts 21a may be attached to the second joint portion 21 via the through holes of the bottom faces 12c of the first joint portion 12.

In this embodiment, a case will be mainly described in which the second joint portion 21 is formed in one piece with the output-side waveguide 22 with a constant thickness and the shape of the second hollow portion 23 inside the second joint portion 21 is also a partially solid cylinder-like shape as with the outer shape of the second joint portion 21, that is, the second joint portion 21 has a partially hollow cylinder-like shape with both ends in the axial direction closed, but there is no limitation to this. If the second hollow portion 23 does not have a partially solid cylinder-like shape, for example, the second hollow portion 23 may have a rectangular cuboid shape.

In this embodiment, a case is shown in which the opening planes of the third and fourth openings 24 and 25 are parallel to each other and the opening planes oppose each other with the central axis of the partially solid cylinder-like shape of the second joint portion 21 interposed therebetween, but there is no limitation to this. The opening planes of the third and fourth openings 24 and 25 may not be parallel to each other.

The second joint portion 21 is disposed such that the central axis of the partially solid cylinder-like shape of the second joint portion 21 is coaxial with the central axis of the first hollow portion 13 and the joint portion is pivotable inside the first hollow portion 13 about the central axis of the partially solid cylinder-like shape of the second joint portion 21. More specifically, the second joint portion 21 may be made pivotable inside the first hollow portion 13 of the first joint portion 12 by having the pivoting shafts 21a pass through the through holes of the bottom faces 12c of the first joint portion 12. In order to prevent microwaves from leaking through the gaps between the through holes and the pivoting shafts 21a, for example, microwave leakage preventing portions 6 may be provided outside the through holes as shown in FIG. 1 and the like. The microwave leakage preventing portions 6 may be provided with, for example, a microwave leakage prevention mechanism such as a choke structure.

The gap between the inner side of a peripheral face 12b of the first joint portion 12 and the outer side of a peripheral face 21b of the second joint portion 21 is preferably small. The amount of microwaves that pass through that gap is preferably smaller than that of microwaves that are output from the output-side waveguide 22. The microwaves that pass through that gap are transmitted from the second opening 15 into the cavity 3 and do not leak to the outside of the cavity 3, so this is not a particular problem.

The output-side waveguide 22 is connected to the fourth opening 25. The output-side waveguide 22 outputs microwaves from the second joint portion 21 into the cavity 3 as indicated by the arrow A11 in FIG. 3. As described above, the second joint portion 21 is pivotable in the first hollow portion 13. Therefore, the direction of microwaves that are output from the output-side waveguide 22 changes, for example, in accordance with the pivoting of the second joint portion 21 as indicated by the two sided arrow A12 in FIG. 3. In this case, the second waveguide 20 is pivotable within the range of the second opening 15 of the first joint portion 12.

The operation unit 51 is connected to the second joint portion 21. In this embodiment, as described above, it is assumed that the operation unit 51 is coaxially connected to the pivoting shaft 21a of the second joint portion 21. The operation unit 51 may be a rod-like member as shown in FIG. 1 and the like. The use of the operation unit 51 makes it possible to pivot the second joint portion 21 from the outside of the cavity 3 in a state in which the first waveguide 10 is fixed to the wall of the cavity 3. The second joint portion 21 may be pivoted using the operation unit 51, for example, while microwave irradiation is not being performed or while microwave irradiation is being performed. In the case of the latter, the emitting direction of microwaves into the cavity 3 can be changed while microwave irradiation is being performed.

Microwaves generated by the microwave generator 70 are transmitted, for example, via a waveguide to be input from an end of the input-side waveguide 11 on the flange 11a side, and are further transmitted via the input-side waveguide 11, at least part of the first hollow portion 13 of the first joint portion 12, the second hollow portion 23 of the second joint portion 21, and the output-side waveguide 22 to be output into the cavity 3. That is to say, the first and second waveguides 10 and 20 are continuous with each other such that microwaves can be transmitted from an end of the input-side waveguide 11 on the flange 11a side to an end of the output-side waveguide 22 on the side from which microwaves are output. If microwaves are introduced from the end of the input-side waveguide 11 after the waveguide apparatus 1 is fixed to the cavity 3, it is preferable that microwaves do not leak from the waveguide apparatus 1 to the outside of the cavity 3. Therefore, if there is a gap or the like through which microwaves can pass, a microwave leakage prevention mechanism such as a choke structure is preferably provided as appropriate. The electromagnetic field distribution inside the cavity 3 changes in accordance with a change in the direction of microwaves that are introduced into the cavity 3. Accordingly, the electromagnetic field distribution inside the cavity 3 can be adjusted by introducing microwaves into the cavity 3 using the waveguide apparatus 1 according to this embodiment and changing the output direction of the microwaves through an operation of the operation unit 51, as a result of which, for example, the target 4 can be irradiated with microwaves in an optimal manner. Whether or not the electromagnetic field distribution inside the cavity 3 is in a desired state may be checked, for example, using a sensor that senses microwaves, or may be checked by sensing the temperature, the state, and the like of the target 4. Whether or not the target 4 is in a desired state may be checked, for example, by sensing the temperature and the like of the target 4. The output direction of microwaves may be changed such that the electromagnetic field distribution inside the cavity 3 is in a desired state or such that the target 4 is in a desired state.

As described above, with the waveguide apparatus 1, the microwave irradiation apparatus 100, and the microwave transmitting method according to this embodiment, when microwaves are transmitted from the outside to the inside of the cavity 3, the output direction of microwaves from the second waveguide 20 can be changed inside the cavity 3, and the electromagnetic field distribution inside the cavity 3 can be changed according to the change. Accordingly, for example, the electromagnetic field distribution inside the cavity 3 can be easily adjusted such that microwave irradiation is performed in an optimal manner inside the cavity 3. Since the first waveguide 10 includes the input-side waveguide 11 and the first joint portion 12 and the second waveguide 20 includes the second joint portion 21 and the output-side waveguide 22, it is possible to easily change, with a simple configuration, the angle between the transmission direction of microwaves through the input-side waveguide 11 and the transmission direction of microwaves through the output-side waveguide 22. In the case in which the first waveguide 10 is fixed to the cavity 3, the arrangement of the microwave generator 70 and the like connected to the first waveguide 10 does not have to be changed even when the angle of the second waveguide 20 is changed. Accordingly, the irradiation angle of microwaves can be changed in a state in which the position of the microwave generator 70 is fixed.

In this embodiment, the output-side waveguide 22 may be a waveguide whose length in the longitudinal direction can be changed, for example, a sliding waveguide. A sliding waveguide is a waveguide having a sliding mechanism for extending and retracting the length of the waveguide in the longitudinal direction. The sliding mechanism of a sliding waveguide may be, for example, a telescopic mechanism of a tube or cylinder similar to that of a zoom lens or a telescope. For more information on sliding waveguides, see, for example, JP H8-288710A. If the output-side waveguide 22 is constituted by a sliding waveguide in this manner, the output position of microwaves can be changed, and the electromagnetic field distribution inside the cavity 3 can be adjusted according to the change.

### Embodiment 2

Hereinafter, a waveguide apparatus, a microwave irradiation apparatus, and a microwave transmitting method according to Embodiment 2 of the present invention will be described with reference to the drawings. The waveguide apparatus according to this embodiment is configured such that a first joint portion including a solid cylinder-like shaped hollow portion and a second joint portion including a solid cylinder-like shaped hollow portion that is continuous with the hollow portion are continuous with each other such that the central axes of the hollow portions are coaxial, and the second joint portion is pivotable about the central axes of the hollow portions with respect to the first joint portion.

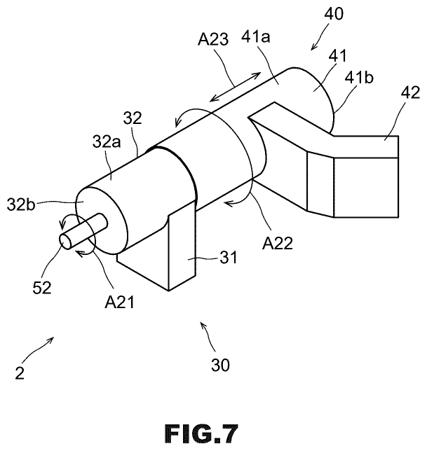

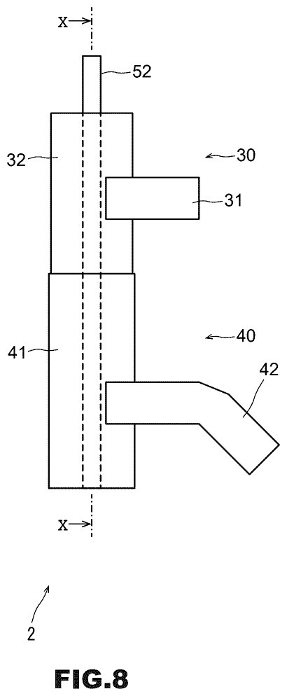

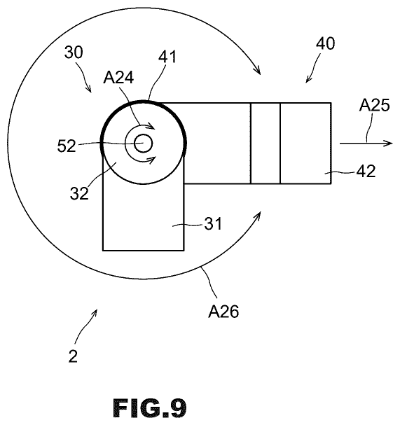

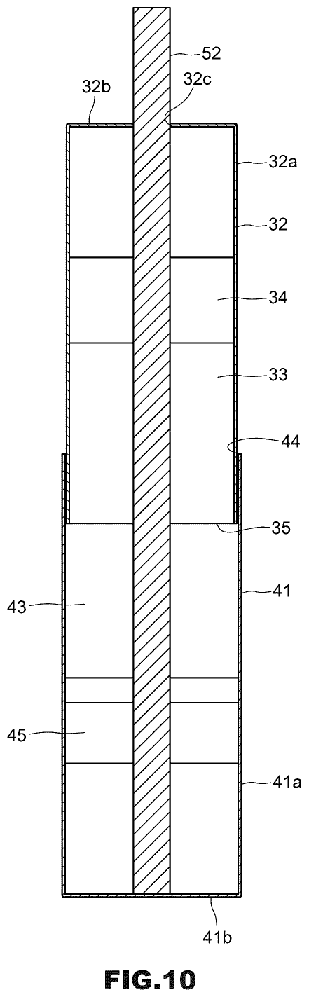

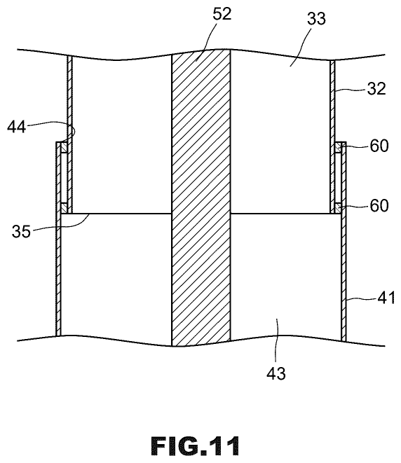

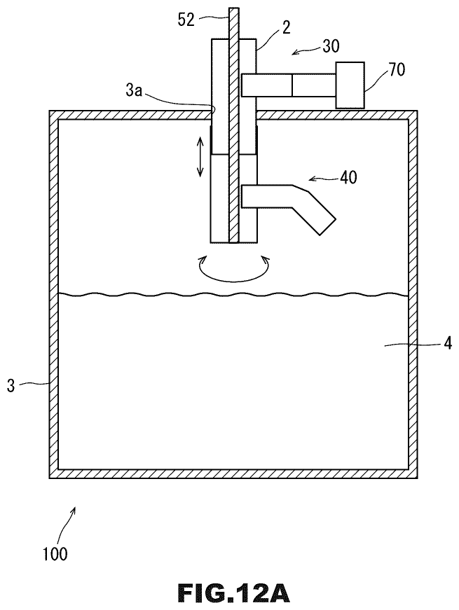

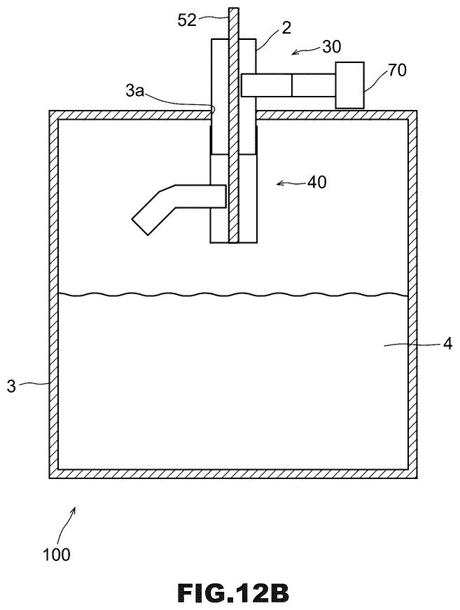

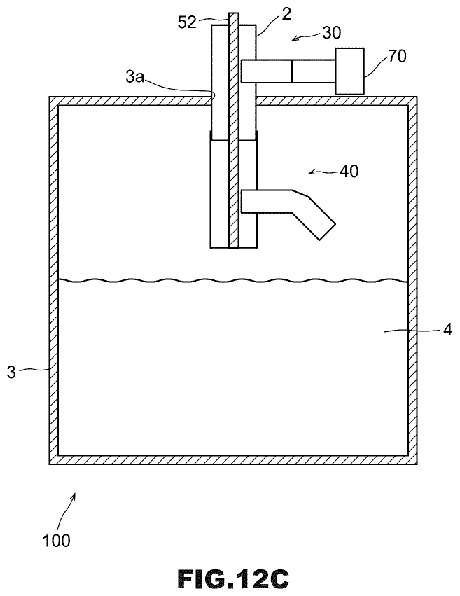

FIG. 7 is a perspective view of a waveguide apparatus 2 according to this embodiment, FIG. 8 is a front view of the waveguide apparatus 2 in which an input-side waveguide 31 and an output-side waveguide 42 are located on the same side, FIG. 9 is a plan view of the waveguide apparatus 2, FIG. 10 is a cross-sectional view taken along the line X-X in FIG. 8, and FIG. 11 is a partially enlarged cross-sectional view of a portion in which a first joint portion 32 and a second joint portion 41 are connected, taken along the line X-X in FIG. 8. FIGS. 12A to 12C are cross-sectional schematic views of the microwave irradiation apparatus 100 including the cavity 3 and the waveguide apparatus 2 that is attached to the cavity 3.

As shown in FIG. 12A and the like, the waveguide apparatus 2 according to this embodiment is also used to introduce microwaves from the outside to the inside of the cavity 3 in which the target 4 is subjected to microwave irradiation, as with the waveguide apparatus 1 of Embodiment 1. The microwave irradiation apparatus 100 includes the waveguide apparatus 2, the cavity 3, and the microwave generator 70. The waveguide apparatus 2 includes a first waveguide 30 that is fixed to the wall of the cavity 3 and a second waveguide 40 through which microwaves from the first waveguide 30 are guided to be output into the cavity 3, and may further include an operation unit 52 for pivoting the second waveguide 40, and spacers 60. The first waveguide 30 is fixed to the wall of the cavity 3 such that at least part of the first waveguide 30, for example, an end of the first waveguide 30 on the side to which microwaves are input is located outside the wall. The second waveguide 40 is connected to the first waveguide 30 such that the output direction of microwaves into the cavity 3 is changeable.

The first waveguide 30 includes an input-side waveguide 31 to which microwaves generated by the microwave generator 70 are input, and a first joint portion 32 that is fixed to the wall of the cavity 3. The first joint portion 32 includes a solid cylinder-like shaped first hollow portion 33 that is connected to the input-side waveguide 31.

The second waveguide 40 includes a second joint portion 41 that includes a solid cylinder-like shaped second hollow portion 43 that is continuous with the first hollow portion 33, and that is pivotably connected to the first joint portion 32, and an output-side waveguide 42 that outputs microwaves from the second joint portion 41 into the cavity 3.

The processing that is performed through microwave irradiation, the microwave generator 70, the frequency of microwaves, and the like are similar to those in Embodiment 1, and thus a detailed description thereof has been omitted. The input-side waveguide 31 and the output-side waveguide 42 are similar to the input-side waveguide 11 and the output-side waveguide 22 of Embodiment 1, and thus a detailed description thereof has been omitted. In this embodiment, as an example, a case will be described in which the output-side waveguide 42 is a corner waveguide in which the transmission direction of microwaves is changed by 45 degrees. The first and second waveguides 30 and 40 are preferably made of a material that does not allow microwaves to pass therethrough. The material that does not allow microwaves to pass therethrough is as in Embodiment 1.

The first joint portion 32 in the first waveguide 30 includes the first hollow portion 33 having a solid cylinder-like shape. In this embodiment, a case will be described in which the first joint portion 32 is formed with a constant thickness and the outer shape of the first joint portion 32 is also a solid cylinder-like shape as with the first hollow portion 33, but there is no limitation to this as will be described later.

The first hollow portion 33 has first and second openings 34 and 35. Accordingly, the first and second openings 34 and 35 are continuous with each other via the first hollow portion 33. The first opening 34 is located on a peripheral face 32a of the first joint portion 32, and is connected to the input-side waveguide 31. In this embodiment, a case will be mainly described in which the input-side waveguide 31 is connected to the first joint portion 32 such that the central axial direction of the first hollow portion 33 and the longitudinal direction of the input-side waveguide 31 are orthogonal to each other, but there is no limitation to this. They may be connected to each other at other angles. The input-side waveguide 31 and the first joint portion 32 may be connected to each other, for example, by welding or the like. The second opening 35 is located at an end of the first hollow portion 33 in the central axial direction. The second opening 35 may be of the same size and same shape as the first hollow portion 33 in a plane that is perpendicular to the central axis of the first hollow portion 33. That is to say, the entire face of the first joint portion 32 at an end in the central axial direction may be open. The central axis of the first hollow portion 33 is the central axis of the peripheral face of the first hollow portion 33. The first joint portion 32 can be said to have a hollow cylinder-like shape whose end on one side in the axial direction is closed by a bottom face 32b and end on the other side is open and whose peripheral face has the first opening 34. The bottom face 32b that is an end face of the first joint portion 32 on the side opposite to the second opening 35 has a through hole 32c through which the operation unit 52 whose cross-section that is perpendicular to the longitudinal direction has a circular shape extends. In order to prevent microwaves from leaking through the gap between the through hole 32c and the operation unit 52, a microwave leakage prevention mechanism such as a choke structure may be provided.

The first joint portion 32 may be fixed to the wall of the cavity 3 such that the central axis of the first hollow portion 33 is perpendicular or nearly perpendicular to the plane direction of the wall as shown in FIG. 12A and the like. Accordingly, as shown in FIG. 12A and the like, part of the first joint portion 32 may be located inside the wall of the cavity 3. For example, as shown in FIG. 12A, the first joint portion 32 may be disposed such that its end on the second opening 35 side is located inside the cavity 3, and fixed to the cavity 3 by welding the peripheral face 32a of the first joint portion 32 to an opening 3a of the cavity 3 of the same size and same shape as the peripheral face 32a of the first joint portion 32. As in Embodiment 1, a mounting plate may be provided on the outer peripheral face of the first joint portion 32, and the first joint portion 32 may be fixed to the cavity 3 via the mounting plate.

The second joint portion 41 in the second waveguide 40 includes the second hollow portion 43 having a solid cylinder-like shape. In this embodiment, a case will be described in which the second joint portion 41 is formed with a constant thickness and the outer shape of the second joint portion 41 is also a solid cylinder-like shape as with the second hollow portion 43, but there is no limitation to this as will be described later.

The second hollow portion 43 has third and fourth openings 44 and 45. Accordingly, the third and fourth openings 44 and 45 are continuous with each other via the second hollow portion 43. The third opening 44 is located at an end of the second hollow portion 43 in the central axial direction. The third opening 44 may be of the same size and same shape as the second hollow portion 43 in a plane that is perpendicular to the central axis of the second hollow portion 43. That is to say, the entire face of the second joint portion 41 at an end in the central axial direction may be open. The central axis of the second hollow portion 43 is the central axis of the peripheral face of the second hollow portion 43. Microwaves from the first hollow portion 33 are guided to the third opening 44. An end of the operation unit 52 may be fixed to an inner face of a bottom face 41b that is an end face of the second joint portion 41 on the side opposite to the third opening 44. This fixing may be performed, for example, by screwing, welding, or gluing. The fourth opening 45 is located on a peripheral face 41a of the second joint portion 41, and is connected to the output-side waveguide 42. In this embodiment, a case will be mainly described in which the output-side waveguide 42 is connected to the second joint portion 41 such that the central axial direction of the second hollow portion 43 and the longitudinal direction of the output-side waveguide 42 are orthogonal to each other, but there is no limitation to this. They may be connected to each other at other angles. The second joint portion 41 and the output-side waveguide 42 may be connected to each other, for example, by welding or the like. The second joint portion 41 can be said to have a hollow cylinder-like shape whose end on one side in the axial direction is closed by the bottom face 41b and end on the other side is open and whose peripheral face has the fourth opening 45.

The first and second joint portions 32 and 41 are connected to each other such that the first and second hollow portions 33 and 43 are coaxially continuous with each other. The first and second joint portions 32 and 41 are connected to each other such that the second joint portion 41 is pivotable about the central axis of the second hollow portion 43 with respect to the first joint portion 32. Therefore, as shown in FIG. 7, the second joint portion 41 is pivotable with respect to the first joint portion 32 as indicated by the two sided arrow A22. The first and second joint portions 32 and 41 may be connected to each other by inserting the first joint portion 32 into the second joint portion 41 or inserting the second joint portion 41 into the first joint portion 32 such that the bottom faces 32b and 41b oppose each other. In this embodiment, the case of the former as shown in FIG. 10 and the like will be mainly described. In the case of the former, that is, in the case in which the second joint portion 41 is on the outer side, the outer shape of the second joint portion 41 does not have to be a solid cylinder-like shape, and may be, for example, a rectangular cuboid shape or the like. In the case of the latter, that is, in the case in which the first joint portion 32 is on the outer side, the outer shape of the first joint portion 32 does not have to be a solid cylinder-like shape, and may be, for example, a rectangular cuboid shape or the like.

The second joint portion 41 may be connected so as to be movable in the central axial direction of the second hollow portion 43 with respect to the first joint portion 32. That is to say, as shown in FIG. 7, the second joint portion 41 may be movable in the direction indicated by the two sided arrow A23 with respect to the first joint portion 32.

The circular spacers 60 may be arranged in the gap between the first and second joint portions 32 and 41 as shown in FIG. 11. The number of spacers 60 may be one, or two or more. The spacers 60 may be made of, for example, an electrically insulating material. The electrically insulating material may be, for example, a resin, a ceramic, or the like. The spacers 60 may be made of a microwave-transmissive material such as a fluororesin such as polytetrafluoroethylene, a ceramic, or the like. In FIG. 11, for example, the upper spacer 60 in the drawing may be fixed to the inner peripheral face of the second joint portion 41, and the lower spacer 60 may be fixed to the outer peripheral face of the first joint portion 32. In this case, the two spacers 60 also function as stoppers, preventing the second joint portion 41 from pulling out from the outer peripheral face of the first joint portion 32.

In FIG. 11, the first joint portion 32 is inserted into the second joint portion 41, and thus the spacers 60 are arranged between the outer peripheral face of the first joint portion 32 and the inner peripheral face of the second joint portion 41, but, in the opposite case, that is, in the case in which the second joint portion 41 is inserted into the first joint portion 32, the spacers 60 are arranged between the outer peripheral face of the second joint portion 41 and the inner peripheral face of the first joint portion 32.

The amount of microwaves that pass through the gap between the first and second joint portions 32 and 41 is preferably smaller than that of microwaves that are output from the output-side waveguide 42. The microwaves that pass through that gap are transmitted from the second opening 35 into the cavity 3 and do not leak to the outside of the cavity 3, so this is not a particular problem.

The output-side waveguide 42 is connected to the fourth opening 45. The output-side waveguide 42 outputs microwaves from the second joint portion 41 into the cavity 3 as indicated by the arrow A25 in FIG. 9. As described above, the second joint portion 41 is pivotable about the central axis. Therefore, the direction of microwaves that are output from the output-side waveguide 42 changes, for example, in accordance with the pivoting of the second joint portion 41 as indicated by the two sided arrow A26 in FIG. 9.

The operation unit 52 is connected to the second joint portion 41. In this embodiment, as described above, it is assumed that the operation unit 52 is connected to the inner side of the bottom face 41b of the second joint portion 41 so as to be coaxial with the normal direction that passes through the circular center of the bottom face 41b. The use of the operation unit 52 makes it possible to pivot the second joint portion 41 from the outside of the cavity 3 in a state in which the first waveguide 30 is fixed to the wall of the cavity 3. For example, in FIGS. 7 and 9, the second joint portion 41 can be pivoted in the directions indicated by the two sided arrows A22 and A26 by pivoting the operation unit 52 in the directions indicated by the two sided arrows A21 and A24. For example, the second joint portion 41 can be moved in the direction indicated by the two sided arrow A23 in FIG. 7 by moving the operation unit 52 in the central axial direction. The second joint portion 41 may be pivoted or moved in the axial direction using the operation unit 52, for example, while microwave irradiation is not being performed or while microwave irradiation is being performed. In the case of the latter, the emitting direction or the emitting position of microwaves into the cavity 3 can be changed while microwave irradiation is being performed. The operation unit 52 may be made of, for example, a microwave-reflective or microwave-transmissive material. If the operation unit 52 is made of a microwave-transmissive material, in order to prevent microwaves from leaking from the through hole 32c, for example, the through hole 32c may be provided to attenuate the microwaves or the electromagnetic field distribution may be controlled to prevent microwaves from leaking from the through hole 32c.

Microwaves generated by the microwave generator 70 are transmitted, for example, via a waveguide to be input from an end of the input-side waveguide 31, and are further transmitted via the input-side waveguide 31, the first hollow portion 33 of the first joint portion 32, the second hollow portion 43 of the second joint portion 41, and the output-side waveguide 42 to be output into the cavity 3. That is to say, the first and second waveguides 30 and 40 are continuous with each other such that microwaves can be transmitted from an end of the input-side waveguide 31 to an end of the output-side waveguide 42 on the side from which microwaves are output. If microwaves are introduced from the end of the input-side waveguide 31 after the waveguide apparatus 2 is fixed to the cavity 3, it is preferable that microwaves do not leak from the waveguide apparatus 2 to the outside of the cavity 3. Therefore, if there is a gap or the like through which microwaves can pass, a microwave leakage prevention mechanism such as a choke structure is preferably provided as appropriate. The electromagnetic field distribution inside the cavity 3 changes in accordance with a change in the direction of microwaves that are introduced into the cavity 3. For example, if the direction of microwaves that are introduced into the cavity 3 changes from the state shown in FIG. 12A to the state shown in FIG. 12B, the electromagnetic field distribution inside the cavity 3 changes. The electromagnetic field distribution inside the cavity 3 changes in accordance with a change in the output position of microwaves that are introduced into the cavity 3. For example, if the output position of microwaves that are introduced into the cavity 3 changes from the state shown in FIG. 12A to the state shown in FIG. 12C, the electromagnetic field distribution inside the cavity 3 changes. Accordingly, the electromagnetic field distribution inside the cavity 3 can be adjusted by introducing microwaves into the cavity 3 using the waveguide apparatus 2 according to this embodiment and changing the output direction and the output position of the microwaves through an operation of the operation unit 52, as a result of which, for example, the target 4 can be irradiated with microwaves in an optimal manner.

As described above, with the waveguide apparatus 2, the microwave irradiation apparatus 100, and the microwave transmitting method according to this embodiment, when microwaves are transmitted from the outside to the inside of the cavity 3, the output direction of microwaves from the second waveguide 20 can be changed inside the cavity 3, and the electromagnetic field distribution inside the cavity 3 can be changed according to the change. Accordingly, for example, the electromagnetic field distribution inside the cavity 3 can be easily adjusted such that microwave irradiation is performed in an optimal manner inside the cavity 3. Since the first waveguide 30 includes the input-side waveguide 31 and the first joint portion 32 and the second waveguide 40 includes the second joint portion 41 and the output-side waveguide 42, it is possible to easily change, with a simple configuration, the angle between the transmission direction of microwaves through the input-side waveguide 31 and the transmission direction of microwaves through the output-side waveguide 42 as viewed from the axial direction of the first and second hollow portions 33 and 43, as well as the position of the output-side end of the output-side waveguide 42 in the central axial direction of the first and second joint portions 32 and 41. Since the spacers 60 are arranged in the gap between the first and second joint portions 32 and 41, the distance between the joint portions can be kept constant and the possibility of sparks occurring between them can be reduced. Since the first waveguide 30 is fixed to the cavity 3, the arrangement of the microwave generator 70 and the like connected to the first waveguide 30 does not have to be changed even when the angle of the second waveguide 40 is changed. Accordingly, the irradiation angle or the irradiation position of microwaves can be changed in a state in which the position of the microwave generator 70 is fixed.

In this embodiment, a case was mainly described in which the spacers 60 are arranged in the gap between the first and second joint portions 32 and 41, but there is no limitation to this. For example, if occurrence of sparks in cavity 3 is not a problem, the spacers 60 do not have to be arranged in the gap between the first and second joint portions 32 and 41.

In this embodiment, a case was mainly described in which the second joint portion 41 is movable in the central axial direction with respect to the first joint portion 32, that is, the first and second joint portions 32 and 41 constitute a sliding waveguide, but there is no limitation to this. The second joint portion 41 does not have to be movable in the central axial direction with respect to the first joint portion 32.

### Embodiment 3

Hereinafter, a waveguide apparatus according to Embodiment 3 of the present invention will be described with reference to the drawings. The waveguide apparatus according to this embodiment is configured such that a first joint portion including a solid cylinder-like shaped hollow portion and a second joint portion including a solid cylinder-like shaped hollow portion that is continuous with the hollow portion are continuous with each other such that the central axes of the hollow portions are coaxial as with the waveguide apparatus of Embodiment 2, and such that an end of the second joint portion is provided with a mechanism that can change the output direction of microwaves as with the waveguide apparatus of Embodiment 1.

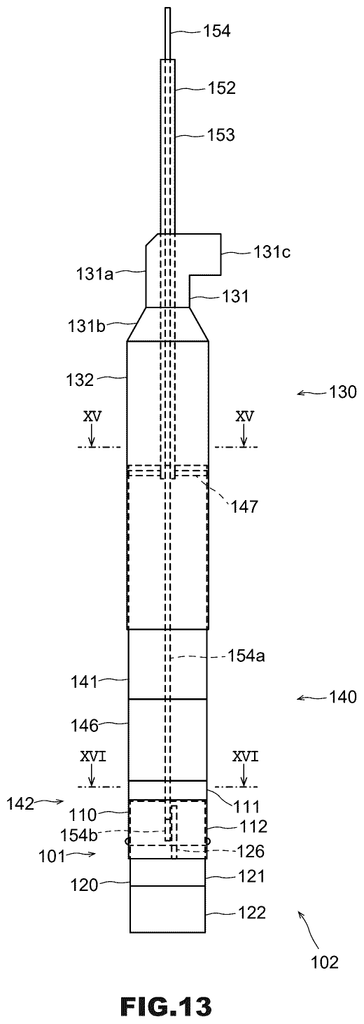

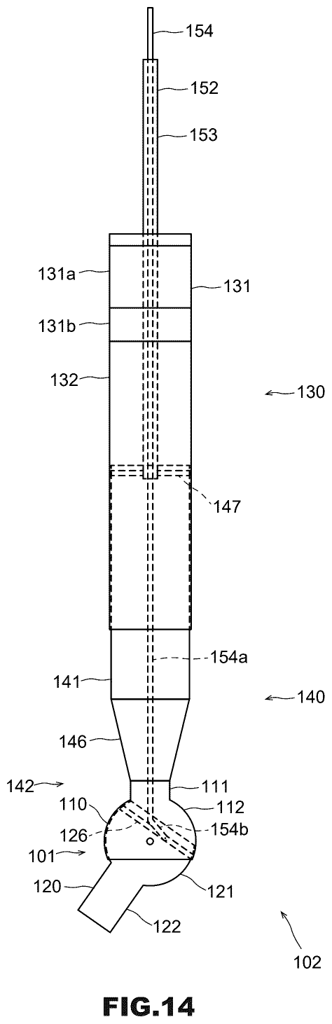

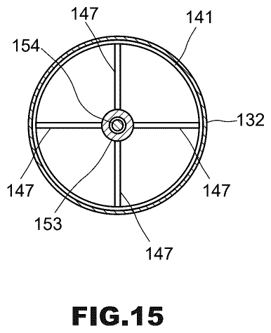

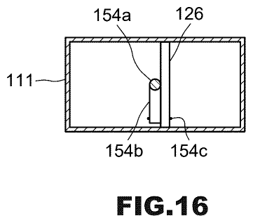

FIG. 13 is a front view of a waveguide apparatus 102 according to this embodiment, and FIG. 14 is a left side view of the waveguide apparatus 102. FIG. 15 is a cross-sectional schematic view taken along the line XV-XV in FIG. 13, and FIG. 16 is a cross-sectional schematic view taken along the line XVI-XVI in FIG. 13. FIG. 15 mainly shows a state in which an outer operation unit 153 is connected to rod-like members 147, FIG. 16 mainly shows a state in which an inner operation unit 154 is connected to a rod-like member 126, and other constituent elements are omitted as appropriate. As with the waveguide apparatuses 1 and 2 of Embodiments 1 and 2, the waveguide apparatus 102 according to this embodiment is also attached to the cavity 3, and is used to introduce microwaves generated by the microwave generator 70 into the cavity 3.

The waveguide apparatus 102 according to this embodiment includes a first waveguide 130 that is fixed to the wall of the cavity 3, a second waveguide 140 through which microwaves from the first waveguide 130 are guided to be output into the cavity 3, and an operation unit 152. The operation unit 152 includes an outer operation unit 153 having a hollow cylinder-like shape and an inner operation unit 154. The inner operation unit 154 includes a main portion 154a extending through the interior of the outer operation unit 153 and a tip portion 154b connected at an angle to the main portion 154a. Each of the main portion 154a and the tip portion 154b is a rod-like member extending in one direction, and may have, for example, a solid cylinder-like shape. In order to prevent microwaves from leaking through the gap between the outer operation unit 153 and the inner operation unit 154, a microwave leakage prevention mechanism such as a choke structure may be provided. The first waveguide 130 is fixed to the wall of the cavity 3 such that at least part of the first waveguide 130, for example, an end of the first waveguide 130 on the side to which microwaves are input is located outside the wall. The second waveguide 140 is connected to the first waveguide 130 such that the output direction of microwaves into the cavity 3 is changeable.

The first waveguide 130 includes an input-side waveguide 131 to which microwaves generated by the microwave generator 70 are input from an opening 131c, and a first joint portion 132 that includes a solid cylinder-like shaped first hollow portion and is fixed to the wall of the cavity 3. The first joint portion 132 has openings at both ends in the central axial direction of the first hollow portion, and guides microwaves from the input-side waveguide 131 connected to one of the ends to the second waveguide 140.

The input-side waveguide 131 includes a corner waveguide 131a in which the microwave guide path is bent at a right angle and the outer circumference of the corner portion is beveled, and a conversion waveguide 131b that is for connecting a rectangular waveguide and a circular waveguide and is connected to the corner waveguide 131a. The corner waveguide 131a has a rectangular cross-section and the first joint portion 132 has a circular cross-section, and thus they are connected to each other via the conversion waveguide 131b. The corner waveguide 131a and the conversion waveguide 131b may be connected to each other, for example, via a flange or by welding or the like. The conversion waveguide 131b and the input-side end of the first joint portion 132 may be connected to each other, for example, via a flange or by welding or the like. The corner waveguide 131a has a through hole through which the operation unit 152 extends. In order to prevent microwaves from leaking through the gap between the through hole and the operation unit 152, a microwave leakage prevention mechanism such as a choke structure may be provided. The outer operation unit 153 and the inner operation unit 154 may be made of, for example, a microwave-reflective or microwave-transmissive material. If the outer operation unit 153 and the inner operation unit 154 are made of a microwave-transmissive material, in order to prevent microwaves from leaking from the through hole of the corner waveguide 131a, for example, the through hole may be provided to attenuate the microwaves or the electromagnetic field distribution may be controlled to prevent microwaves from leaking from the through hole. The input-side waveguide 131 may be provided with a bent waveguide instead of the corner waveguide 131a.

The second waveguide 140 includes a second joint portion 141 that includes a solid cylinder-like shaped second hollow portion that is continuous with the first hollow portion, and that is pivotably connected to the first joint portion 132, and an output-side waveguide 142 that outputs microwaves from the second joint portion 141 into the cavity 3. The second joint portion 141 has openings at both ends in the central axial direction of the second hollow portion, and guides microwaves introduced from one of the ends to the output-side waveguide 142 connected to the other end.

The first joint portion 132 and the second joint portion 141 are respectively similar to the first joint portion 32 and the second joint portion 41 of Embodiment 2, except that the connection position of the input-side waveguide 131 to the first joint portion 132 is different and the connection position of the output-side waveguide 142 to the second joint portion 141 is different, and thus a detailed description thereof has been omitted.

The output-side waveguide 142 includes a conversion waveguide 146 for connecting a circular waveguide and a rectangular waveguide, and a direction change mechanism 101 that is connected to the conversion waveguide 146 and configured to change the output direction of microwaves. It is assumed that the end of the direction change mechanism 101 on the side to which microwaves are input is a rectangular waveguide. Meanwhile, the second joint portion 141 has a circular cross-section, and thus the direction change mechanism 101 and the second joint portion 141 are connected to each other via the conversion waveguide 146. The second joint portion 141 and the conversion waveguide 146 may be connected to each other, for example, via a flange or by welding or the like. The conversion waveguide 146 and the input-side end of the direction change mechanism 101 may be connected to each other, for example, via a flange or by welding or the like. If the input-side end of the direction change mechanism 101 is not a rectangular waveguide but a circular waveguide, the output-side waveguide 142 does not have to include the conversion waveguide 146. In this case, the input-side end of the direction change mechanism 101 may be directly connected to the output-side end of the second joint portion 141.

The direction change mechanism 101 includes a third waveguide 110 for microwaves that is connected to the conversion waveguide 146, and a fourth waveguide 120 through which microwaves from the third waveguide 110 are guided to be output into the cavity 3. The fourth waveguide 120 is connected to the third waveguide 110 such that the output direction of microwaves into the cavity 3 is changeable. The third waveguide 110 includes an input-side waveguide 111 to which microwaves are input, and a third joint portion 112. The fourth waveguide 120 includes a fourth joint portion 121, and an output-side waveguide 122 that outputs microwaves from the fourth joint portion 121 into the cavity 3. The third waveguide 110, the fourth waveguide 120, the input-side waveguide 111, the third joint portion 112, the fourth joint portion 121, and the output-side waveguide 122 are respectively similar to the first waveguide 10, the second waveguide 20, the input-side waveguide 11, the first joint portion 12, the second joint portion 21, and the output-side waveguide 22 of Embodiment 1, except that the fourth waveguide 120 is pivoted not by the operation unit 51 but by the inner operation unit 154, and thus a detailed description thereof has been omitted.

The operation unit 152 can pivot the second joint portion 141 and the fourth joint portion 121 from the outside of the cavity 3 in a state in which the waveguide apparatus 102 is fixed to the wall of the cavity 3. The second joint portion 141 is operated by the outer operation unit 153 included in the operation unit 152, and the fourth joint portion 121 is operated by the inner operation unit 154 included in the operation unit 152.

The outer operation unit 153 is fixed to the inner peripheral face of the second joint portion 141, and can pivot the second joint portion 141. The outer operation unit 153 may be fixed to the inner peripheral face of the second joint portion 141 via other members. Specifically, as shown in FIG. 15, the outer operation unit 153 may be fixed to the inner peripheral face of the second joint portion 141 via four rod-like members 147. FIG. 15 shows a case in which the number of rod-like members 147 is four, but any number of rod-like members 147 may be used to fix the outer operation unit 153 to the second joint portion 141. The number of rod-like members 147 may be, for example, two or three, or five or more. The multiple rod-like members 147 are preferably arranged at an equal angle about the central axis of the second hollow portion. Since the outer operation unit 153 is fixed to the second joint portion 141, the second joint portion 141 can be pivoted by pivoting the operation unit 152. The outer operation unit 153 may be fixed to the second joint portion 141 via members other than the rod-like members 147. FIGS. 13 and 14 show a case in which the outer operation unit 153 is fixed to the input-side end of the second joint portion 141, but there is no limitation to this. The outer operation unit 153 may be fixed to the second joint portion 141 at any position other than the input-side end.

The inner operation unit 154 is connected to the eccentric position of the fourth joint portion 121, and can pivot the fourth joint portion 121. The inner operation unit 154 may be fixed to the eccentric position of the fourth joint portion 121 via other members. Specifically, the rod-like member 126 may be fixed to the hollow portion inside the fourth joint portion 121. The rod-like member 126 may be provided such that its longitudinal direction is perpendicular to the central axis of the partially solid cylinder-like shape of the fourth joint portion 121 and is parallel to the opening plane of the opening of the fourth joint portion 121 on the side opposite to the output-side waveguide 122. As shown in FIG. 16, an end of the tip portion 154b of the inner operation unit 154 may be pivotably connected to the rod-like member 126 via a shaft member 154c. Since the connection position is not at the longitudinal center of the rod-like member 147, the inner operation unit 154 is connected to the eccentric position of the fourth joint portion 121, and the fourth waveguide 120 can be pivoted with respect to the third waveguide 110 by moving the inner operation unit 154 in the vertical direction in FIGS. 13 and 14 in a state in which the outer operation unit 153 is fixed.

The rod-like members 126 and 147 are preferably made of a material that does not reflect microwaves. The material that does not reflect microwaves is preferably a microwave-transmissive material. A circular spacer may be disposed in the gap between the first and second joint portions 132 and 141. In this embodiment, the first joint portion 132 may be inserted into the second joint portion 141. In this case, the outer operation unit 153 may be fixed to the output-side end of the second joint portion 141.

As described above, with the waveguide apparatus 102 according to this embodiment, the position of the output-side end of the output-side waveguide 142 can be changed by moving the operation unit 152 in the longitudinal direction. Furthermore, the output direction of microwaves can be changed by pivoting the operation unit 152 or by moving the inner operation unit 154 in the longitudinal direction with respect to the outer operation unit 153. The central axial direction of the second waveguide 140 pivoting in accordance with the pivoting of the operation unit 152 is orthogonal to the central axial direction of the fourth waveguide 120 pivoting in accordance with the movement of the inner operation unit 154 in the longitudinal direction with respect to the outer operation unit 153. Thus, with the waveguide apparatus 102 according to this embodiment, microwaves can be output in more diverse directions into the cavity 3.

In Embodiments 1 to 3, a case was described in which the operation unit 51, 52, 152 is a rod-like member, but may be of any other shape as long as the operation unit 51, 52, 152 can properly operate the second joint portion 21, 41, 141 and the like.

In Embodiments 1 to 3, a case was described in which the operation unit 51, 52, 152 is used to adjust the output direction of microwaves into the cavity 3 from the outside in a state in which the waveguide apparatus 1, 2, 102 is attached to the cavity 3, but there is no limitation to this. The waveguide apparatus 1, 2, 102 does not have to include the operation unit 51, 52, 152. In this case, for example, the output direction of microwaves into the cavity 3 may be adjusted by opening the cavity 3 and changing the direction of the output-side waveguide 22, 42, 142, and the like while microwave irradiation is not being performed.

In Embodiments 1 to 3, a case was described in which the first joint portion 12, 32, 132 is fixed to the wall of the cavity 3, but there is no limitation to this. Any portion of the first waveguide 10, 30, 130 may be fixed to the wall of the cavity 3. For example, the input-side waveguide 11, 31, 131 may be fixed to the wall of the cavity 3. In the case in which any portion of the first waveguide 10, 30, 130 is fixed to the wall of the cavity 3, it is preferably fixed such that at least part thereof, for example, an end to which microwaves are input is located outside the wall of the cavity 3.

In Embodiments 1 to 3, an example of a waveguide apparatus was described including: a first waveguide for microwaves that is fixed to a wall of a cavity in which a target is subjected to microwave irradiation; and a second waveguide through which microwaves from the first waveguide are guided into the cavity, wherein the second waveguide is connected to the first waveguide such that an output direction of microwaves into the cavity is changeable, but the waveguide apparatus may have a configuration other than those in Embodiments 1 to 3. For example, an end of the first waveguide and an end of the second waveguide may be connected to each other through a mechanism similar to a punkah louver. That is to say, the first waveguide may include: an input-side waveguide to which microwaves generated by a microwave generator are input; and a first joint portion having a partially sphere-like shaped hollow portion in which a first opening that is connected to the input-side waveguide and a second opening that is continuous with the first opening are provided such that opening planes thereof oppose each other. The second waveguide may include: a second joint portion having a partially sphere-like shape in which a third opening to which microwaves from the first opening are guided and a fourth opening that is continuous with the third opening are provided such that opening planes thereof oppose each other, the second joint portion being disposed such that a center of the partially sphere-like shape matches a center of the hollow portion of the first joint portion and the second joint portion is pivotable inside the hollow portion of the first joint portion about the center of the partially sphere-like shape; and an output-side waveguide that is connected to the fourth opening and configured to output microwaves into the cavity. The center of the partially sphere-like shape is the center of the peripheral face other than the openings. The hollow portion connecting the third and fourth openings may also have a partially sphere-like shape. The hollow portion of the first joint portion has a partially sphere-like shape due to the provision of such openings in a sphere-like shape. The sphere-like shape may be a regular spherical shape, that is, a shape whose cross-section taken at any point is a regular circle, or a shape whose cross-section is slightly deviated from a regular circle, for example, an oval shape.

In Embodiments 1 to 3, a waveguide apparatus was mainly described in which the output direction of microwaves into the cavity 3 is changeable, but there is no limitation to this. As described above, the electromagnetic field distribution inside the cavity 3 can be also changed by changing the output position of microwaves in the cavity 3. Accordingly, the waveguide apparatus may be configured to change the output position of microwaves in the cavity 3. In this case, the waveguide apparatus may include: a first waveguide for microwaves that is fixed to a wall of a cavity in which a target is subjected to microwave irradiation; and a second waveguide through which microwaves from the first waveguide are guided into the cavity, wherein the second waveguide is connected to the first waveguide such that an output position of microwaves, that is, a position of an output-side end of the second waveguide in the cavity is changeable. The change in the output position may be a change in the position in the linear direction. In this case, for example, the first and second waveguides may constitute a sliding waveguide.

In Embodiments 1 to 3, a case was described in which the operation unit 51, 52, 152 can manually pivot the second joint portion 21, 41, 141 from the outside of the cavity 3, but the second waveguide 20, 40, 140 may be pivotable with respect to the first waveguide 10, 30, 130 through automatic control. Therefore, for example, the second joint portion 21, 41, 141 may be pivoted not by the operation units but by a driving unit that pivots the second joint portion 21, 41, 141. In this case, in order to allow the second joint portion 21, 41, 141 to be automatically pivoted from the outside of the cavity 3 in a state in which the first waveguide 10, 30, 130 is fixed to the wall of the cavity 3, the waveguide apparatus 1, 2, 102 may further include: a shaft member connected to the second joint portion 21, 41, 141 and extending in the pivoting axial direction of the second joint portion 21, 41, 141 to the outside of the cavity 3; and a driving unit such as a motor for pivoting the shaft member outside the cavity 3. The shaft member may be, for example, a rod-like member connected to the second joint portion 21, 41, 141 as with the operation unit 51, 52, 152 and extending to the outside of the cavity 3. The output direction of microwaves into the cavity 3 can be automatically changed by pivoting the second joint portion 21, 41, 141 by causing the driving unit to pivot the shaft member. The pivoting of the second joint portion 21, 41, 141 may be a circular movement of the second joint portion 21, 41, 141 in one direction and the opposite direction about the pivoting shaft, and, if the circular movement in one direction can be continued as with the second joint portion 41, 141, the circular movement in one direction, that is, rotation may be included. The waveguide apparatus 1, 2, 102 may further include, for example, a control unit for controlling the driving unit. The control unit may, for example, control the driving unit according to an instruction accepted from a user, control the driving unit in a predetermined manner, or control the driving unit such that microwave irradiation is performed in a desired manner based on a sensing result, which is output from a sensor for sensing the state inside the cavity 3. The sensor may be, for example, a temperature sensor, a sensor for measuring the intensity of microwaves, or the like.

The present invention is not limited to the embodiments set forth herein. Various modifications are possible within the scope of the present invention.

1. A waveguide apparatus comprising:
a first waveguide for microwaves that is fixed to a wall of a cavity so as to be at least partially located outside the wall, a target inside the cavity being subjected to microwave irradiation; and
a second waveguide through which microwaves from the first waveguide are guided to be output into the cavity,
wherein the second waveguide is connected to the first waveguide such that an output direction of microwaves into the cavity is changeable.

2. The waveguide apparatus according to claim 1,
wherein the first waveguide includes:
an input-side waveguide to which microwaves generated by a microwave generator are input; and
a first joint portion having a first central axis and including a partially solid cylinder-like shaped hollow portion in which a first opening that is connected to the input-side waveguide and a second opening arranged to be continuous with the first opening, and
the second waveguide includes:
a second joint portion having a second central axis and having a partially solid cylinder-like shape in which a third opening to which microwaves from the first opening are guided and a fourth opening arranged to be continuous with the third opening, the second joint portion being disposed so as to be pivotable inside the hollow portion about the second central axis; and
an output-side waveguide that is connected to the fourth opening and configured to output microwaves into the cavity.

3. The waveguide apparatus according to claim 2, wherein the first central axis and the second central axis are coaxial.

4. The waveguide apparatus according to claim 2,
wherein the first opening and the second opening are located such that opening planes thereof are parallel to the first central axis, and
the third opening and the fourth opening are located such that opening planes thereof are parallel to the second central axis.

5. The waveguide apparatus according to claim 1,
wherein the first waveguide includes:
an input-side waveguide to which microwaves generated by a microwave generator are input; and
a first joint portion having a solid cylinder-like shaped first hollow portion whose peripheral face has a first opening that is connected to the input-side waveguide and whose end in a central axial direction thereof has a second opening that is continuous with the first opening, and
the second waveguide includes:
a second joint portion having a solid cylinder-like shaped second hollow portion whose end in a central axial direction thereof has a third opening to which microwaves from the first hollow portion are guided and whose peripheral face has a fourth opening that is continuous with the third opening, the second joint portion being connected to the first joint portion so as to be pivotable about the central axis of the second hollow portion with respect to the first joint portion; and
an output-side waveguide that is connected to the fourth opening and configured to output microwaves into the cavity.

6. The waveguide apparatus according to claim 5, wherein the first and second hollow portions are coaxially continuous with each other.

7. The waveguide apparatus according to claim 5, wherein the second joint portion is connected so as to be movable in the central axial direction of the second hollow portion with respect to the first joint portion.

8. The waveguide apparatus according to claim 5, wherein a circular spacer is provided in a gap between the first and second joint portions.

9. The waveguide apparatus according to claim 2, further comprising:
an operation unit that is connected to the second joint portion and configured to pivot the second joint portion from an outside of the cavity in a state in which the first waveguide is fixed to the wall of the cavity.

10. A microwave irradiation apparatus comprising:
a microwave generator that generates microwaves;
a cavity in which a target is subjected to microwave irradiation; and
the waveguide apparatus according to claim 1, fixed to the cavity and configured to introduce microwaves generated by the microwave generator into the cavity.

11. A microwave transmitting method for transmitting microwaves from an outside to an inside of a cavity in which a target is subjected to microwave irradiation, using a waveguide apparatus including a first waveguide for microwaves that is fixed to a wall of the cavity so as to be at least partially located outside the wall, and a second waveguide through which microwaves from the first waveguide are guided to be output into the cavity, the second waveguide being connected to the first waveguide such that an output direction of microwaves into the cavity is changeable, comprising:
a step of changing an output direction of microwaves from the second waveguide into the cavity.

12. The microwave transmitting method according to claim 11, further comprising:
a step of sensing an electromagnetic field distribution or a state of the target inside the cavity,
wherein, in the step of changing an output direction of microwaves, the output direction of microwaves from the second waveguide is changed using a sensing result such that the electromagnetic field distribution or the target is in a desired state.
